(19) United States
(12) Patent Application Publication
(10) Pub. No.: US 2006/0079615 A1
(43) Pub. Date: Apr. 13, 2006

(54) Stabilized blends of polycarbonate with emulsion derived polymers

(76) Inventors: James Louis DeRudder, Mt. Vernon, IN (US); Robert Russell Gallucci, Mt. Vernon, IN (US)

Correspondence Address: Henry H. Bibson;GE Plastics, One Plastics Avenue, Pittsfield, MA, 01201, US

(21) Appl. No.: 10/962,643

(22) Filed: Oct. 12, 2004

(51) Int. Cl. C08K 5/524

(52) U.S. Cl. 524/128; 524/502

(57) ABSTRACT

Blends of polycarbonate with emulsion polymerization derived polymers, such as ABS, ASA and MBS, may be stabilized against loss of properties due to the action of water, by addition of calcined alumino magnesium carbonate.

### BACKGROUND OF THE INVENTION

Polycarbonate resins form many blends with emulsion derived vinyl polymers that have useful features, such as high impact, high melt flow, good appearance and improved solvent resistance. However the nature of the vinyl polymers made by an emulsion process creates specific issues with the stability of the polycarbonate (PC) resin used in blends with them. PC is a condensation polymer with carbonic acid ester repeat units. These carbonate linkages can react with water causing the polymer to lose molecular weight and ultimately physical properties. Various catalysts, such as acids and bases or chemical remnants of the emulsion polymerization process that may generate undesired catalysts when the blend is melt processed for molding, may increase the rate of PC hydrolysis. PC resins are relatively sensitive to degradation and are somewhat unusual for condensation polymers in that when they decompose they can give off carbon dioxide, derived from the carbonate linkages. Carbon dioxide generation can cause the PC blend to foam or give a plastic part whose surface is marred by splay, due to carbon dioxide. Such decomposition leaves behind a phenolic end group.

Emulsion polymers are made in water and some ingredients essential to the polymerization process may cause decomposition of PC. For instance, residues of the emulsifier, such as fatty carboxylic acids or their salts can cause issues, with PC stability. In addition emulsion polymerized resins must be separated from the water in which they are made. This separation is frequently done by coagulation; addition of salt water or acid is often used, along with filtration, to separate the emulsion polymer from water. Despite this separation the emulsion polymers often contain varying minor amounts of residues that may cause PC instability. In many cases it is not industrially or economically feasible to totally purify the emulsion polymer from such by-products of its manufacture. For instance in an acid or salt coagulated emulsion polymer, excessive washing may be need to purify the polymer such that it can be used in a PC blend in demanding conditions. However this extra washing may require excessive water leading to increased pollution and or higher treatment costs. In other instances the use of emulsion polymerization adjuncts, such as emulsifier and radical initiators is critical to a successful emulsion polymerization and cannot be removed or substituted for. Therefore it would be beneficial to be able to use the emulsion polymers, as they are isolated from polymerization, in combination with PC. However in demanding applications, such as exposure to water at high temperature, the residues of the emulsion polymerization process can lead to PC breakdown.

### DESCRIPTION OF THE INVENTION

The present invention is directed to the preparation of blends of polycarbonates with emulsions based vinyl polymers, such as acrylonitrile butadiene styrene (ABS), with improved hydrolytic stability. Hydrolytic stability is improved by use of a selected amount of a calcined hydrotalcite. We have found that a specific type of magnesium alumina hydrotalcite, when used at about 0.05 to 5.0 wt % in blends of polycarbonate resin with and emulsion polymer, results in improved stability, specifically improved resistance to decomposition by water. Such hydrotalcite compounds are most effective when heated to high temperature, or calcined prior to combination with the PC - emulsion polymer blends.

Since different types of emulsion polymers made by different processes may contain varying amounts and varying species inimical to PC stability, a process is provided wherein the PC emulsion polymer is combined with various levels of calcined hydrotalcite to determine the minimal level of calcined hydrotalcite needed to improve hydrostability without causing other issues, such as loss of impact or appearance, by addition of too much hydrotalcite stabilizer.

Hydrotalcite is a synthetic or naturally occurring alumino magnesium carbonate. Synthetic hydrotalcite is preferred for its consistency and low color. The effective amount of hydrotalcite needed to improve hydrolytic stability will depend on the amount and type of emulsion polymer blended with PC. Generally the amount of calcined hydrotalcite will be from about 0.005 to 5.0 wt % based on the whole formulation, in most instances levels of from about 0.01 to about 0.5% will give improved hydrolysis resistance. In some instances the hydrotalcite may be calcined from 400-1000° C. In another case the calcined hydrotalcite may have a magnesium oxide to aluminum oxide mole ratio of about 1.0 to 5.0. Calcined hydrotalcite with an average particle size of less than or equal to about 10 microns may be used in some cases to improve impact strength. In other instances, for example when food contact is desired, the calcined hydrotalcite may have less than about 30 ppm of elements selected from the group consisting of: mercury, lead, cadmium, arsenic, bismuth and mixtures thereof. Hydrotalcite which has not been coated or treated with a carboxylic acid, carboxylic acid salt, ammonium salt, alkyl ammonium salt, aryl ammonium salt, polyether surfactant or other wetting agent or surfactant is preferred. These wetting agents and surfactants may catalyze polycarbonate decomposition in a manner analogous to the action of some of the residues of emulsion polymerization.

Polycarbonate resins suitable for use in the present invention are known compounds whose preparation and properties have been described, see, generally, U.S. Pat. Nos. 3,169,121, 4,487,896, 5,411,999 and 6,627303. In one embodiment, the aromatic polycarbonate resin component of the present invention is the reaction product of a dihydric phenol according to the structural formula (I):
HO—A—OH (I)
wherein A is a divalent aromatic radical, with a carbonate precursor and contains structural units according to the formula (II): 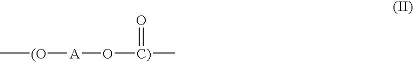
wherein A is defined as above.

As used herein, the term “divalent aromatic radical” includes those divalent radicals containing a single aromatic ring such as phenylene, those divalent radicals containing a condensed aromatic ring system such as, for example, naphthalene, those divalent radicals containing two or more aromatic rings joined by a non-aromatic linkage, such as for example, an alkylene, alkylidene, ether or sulfonyl group, any of which may be substituted at one or more sites on the aromatic ring with, for example, a halo group or (C₁-C₆)alkyl group.

Suitable dihydric phenols include, for example, one or more of 2,2-bis-(4-hydroxyphenyl) propane (“bisphenol A”), 2,2-bis(3,5-dimethyl-4-hydroxyphenyl)propane, bis(4-hydroxyphenyl) methane, 4,4-bis(4-hydroxyphenyl)heptane, 3,5,3′,5′-tetrachloro-4,4′-dihydroxyphenyl)propane, 2,6-dihydroxy naphthalene, resorcinol, hydroquinone, 4,4′-dihydroxydiphenyl sulfone. In one embodiment, the dihydric phenol is bisphenol A, resorcinol or mixtures thereof. In a preferred embodiment, A is a divalent aromatic radical according to the formula (III)

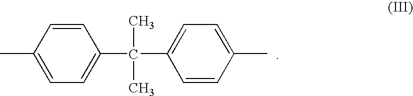

The carbonate precursor is one or more of a carbonyl halide, a carbonate ester or a haloformate. Suitable carbonyl halides include, for example, carbonyl bromide and carbonyl chloride. Suitable carbonate esters include, such as for example, diphenyl carbonate, dichlorophenyl carbonate, di naphthyl carbonate, phenyl tolyl carbonate and di tolyl carbonate. Suitable haloformates include, for example, bishaloformates of a dihydric phenols, such as, for example, bis phenol A, resorcinol or hydroquinone, or glycols, such as, for example, ethylene glycol, neopentyl glycol. In a one embodiment, the carbonate precursor is carbonyl chloride or diphenyl carbonate.

Suitable aromatic polycarbonate resins include linear aromatic polycarbonate resins, branched aromatic polycarbonate resins. Suitable linear aromatic polycarbonates resins include, e.g., bisphenol A polycarbonate resin. Suitable branched polycarbonates are known and are made by reacting a polyfunctional aromatic compound with a dihydric phenol and a carbonate precursor to form a branched polymer, see generally, U.S. Pat. Nos. 3,544,514, 3,635,895 and 4,001,184. The polyfunctional compounds are generally aromatic and contain at least three functional groups which are carboxyl, carboxylic anhydrides, phenols, haloformates or mixtures thereof, such as, for example, 1,1,1-tri(4-hydroxyphenyl)ethane, 1,3,5,-trihydroxy-benzene, trimellitic anhydride, trimellitic acid, trimellitic trichloride, 4-chloroformyl phthalic anhydride, pyromellitic acid, pyromellitic dianhydride, mellitic acid, mellitic anhydride, trimesic acid, benzophenone tetracarboxylic acid, benzophenone-tetracarboxylic dianhydride. The preferred polyfunctional aromatic compounds are 1,1,1-tri(4-hydroxyphenyl)ethane, trimellitic anhydride or trimellitic acid, their haloformate derivatives or mixtures thereof.

In one instance, the polycarbonate resin component of the present invention is a linear polycarbonate resin derived from bisphenol A and phosgene. In another instance, the weight average molecular weight (Mw) of the polycarbonate resin is from about 10,000 to about 200,000 grams per mole (“g/mol”), as determined by gel permeation chromatography relative to polystyrene. In other case a Mw from 15,000 to 80,000 g/mol may be employed. PC resins may typically exhibit an intrinsic viscosity of about 0.3 to about 1.5 deciliters per gram in chloroform at 25° C. Polycarbonate resins are made by known methods, such as, for example, interfacial polymerization, transesterification, solution polymerization or melt polymerization.

Copolyester-carbonate resins suitable for use as the polycarbonate resin component of the present invention are known compounds whose preparation and properties have been described, see, generally, U.S. Pat. Nos. 3,169,121, 4,430,484 and 4,487,896. These copolymers often have aryl carbonate linkages as well as aromatic or aliphatic carboxylic ester linkages. Copolyester-carbonate resins comprise linear or randomly branched polymers that contain recurring carbonate groups, carboxylate groups and alky or aromatic carboxylic ester groups in the polymer chain.

In a preferred embodiment, the copolyester-carbonate resin component of the present invention is derived from a carbonate precursor, at least one dihydric phenol and at least one dicarboxylic acid or dicarboxylic acid equivalent. In one embodiment, the dicarboxylic acid is one according to the formula (IV): 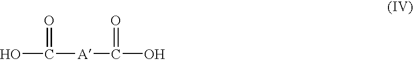
wherein A′ is alkylene, alkylidene, cycloaliphatic or aromatic and may be a non-substituted phenylene radical or a substituted phenylene radical that is substituted at one or more sites on the aromatic ring, wherein each of such substituent groups is independently (C₁-C₆) alkyl, and the copolyester carbonate resin comprises first structural units according to formula (II) above and second structural units according to formula (V): 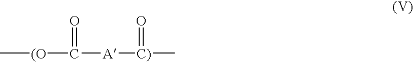
wherein A′ is defined as above. Suitable carbonate precursors and dihydric phenols are those disclosed above.

Examples of dicarboxylic acids, include, for example, isophthalic acid, terephthalic acid, dimethyl terephthalic acid, succinic acid, glutaric acid, adipic acid, fumaric acid, dimer acids, pimelic acid, suberic acid, azelaic acid, sebacic acid, 1,12-dodecanoic acid, cis-1,4-cyclohexane dicarboxylic acid, trans-1,4-cyclohexane dicarboxylic acid, 4,4′- bisbenzoic acid, naphthalene-2,6-dicarboxylic acid and mixtures thereof. Dicarboxylic acid equivalents include, for example, anhydride, ester or halide derivatives of the above disclosed dicarboxylic acids, such as, for example, phthalic anhydride, dimethyl terephthalate, succinyl chloride and mixture thereof. In one instance, the dicarboxylic acid is an aromatic dicarboxylic acid, more preferably one or more of terephthalic acid and isophthalic acid. In other cases polyester carbonates containing ester linkages of resorcinol with iso and terephthalate are useful.

In another case, the ratio of ester bonds to carbonate bonds present in the copolyester carbonate resin is from 0.25 to 0.9 ester bonds per carbonate bond. In a preferred embodiment, the copolyester-carbonate copolymer has a weight average molecular weight of from about 10,000 to about 200,000 g/mol. Copolyester-carbonate resins are made by known methods, such as, for example, interfacial polymerization, transesterification, solution polymerization or melt polymerization.

Emulsion polymerization of vinyl monomers gives rise to a family of addition polymers. In many instances the vinyl emulsion polymers are copolymers containing both rubbery and rigid polymer units. Mixtures of emulsion resins, especially mixtures of rubber and rigid vinyl emulsion derived polymers are useful in PC blends.

In one case rubber modified emulsion polymers are suitable for use as a blend component of the present invention. Such rubber modified thermoplastic resins made by an emulsion polymerization process may comprise a discontinuous rubber phase dispersed in a continuous rigid thermoplastic phase, wherein at least a portion of the rigid thermoplastic phase is chemically grafted to the rubber phase. Such a rubbery emulsion polymerized resin may be further blended with a vinyl polymer made by an emulsion or bulk polymerization process. However, a least a portion of the vinyl polymer, rubbery or rigid phase, blended with polycarbonate, will be made by emulsion polymerization.

Suitable rubbers for use in making a vinyl emulsion polymer PC blend are rubbery polymers those having a glass transition temperature (T_{g}) of less than or equal to 25° C., more preferably less than or equal to 0° C., and even more preferably less than or equal to −30° C. As referred to herein, the T_{g} of a polymer is the T_{g} value of polymer as measured by differential scanning calorimetry (heating rate 20° C./minute, with the T_{g} value being determined at the inflection point). In another embodiment, the rubber comprises a linear polymer having structural units derived from one or more conjugated diene monomers. Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4, hexadiene, dichlorobutadiene, bromobutadiene and dibromobutadiene as well as mixtures of conjugated diene monomers. In a preferred embodiment, the conjugated diene monomer is 1,3-butadiene.

The emulsion polymer may, optionally, include structural units derived from one or more copolymerizable monoethylenically unsaturated monomers selected from (C₂-C ₁₂)olefin monomers, vinyl aromatic monomers and monoethylenically unsaturated nitrile monomers and (C₂-C₁₂)alkyl (meth)acrylate monomers. As used herein, the term “( C₂-C ₁₂)olefin monomers” means a compound having from 2 to 12 carbon atoms per molecule and having a single site of ethylenic unsaturation per molecule. Suitable (C₂-C₁₂)olefin monomers include, e.g., ethylene, propene, 1-butene, 1-pentene, heptene, 2-ethyl-hexylene, 2-ethyl-heptene, 1-octene, and 1-nonene. As used herein, the term “(C₁-C₁₂)alkyl” means a straight or branched alkyl substituent group having from 1 to 12 carbon atoms per group and includes, e.g., methyl, ethyl, n-butyl, sec-butyl, t-butyl, n-propyl, iso-propyl, pentyl, hexyl, heptyl, octyl, nonyl, decyl, undecyl and dodecyl, and the terminology “(meth)acrylate monomers” refers collectively to acrylate monomers and methacrylate monomers

The rubber phase and the rigid thermoplastic resin phase of the emulsion modified vinyl polymer may, optionally include structural units derived from one or more other copolymerizable monoethylenically unsaturated monomers such as, e.g., monoethylenically unsaturated carboxylic acids such as, e.g., acrylic acid, methacrylic acid, itaconic acid, hydroxy(C₁-C₁₂)alkyl (meth)acrylate monomers such as, e.g., hydroxyethyl methacrylate; (C₅-C₁₂)cycloalkyl (meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, vinyl esters such as, e.g., vinyl acetate and vinyl propionate. As used herein, the term “(C₅-C₁₂)cycloalkyl” means a cyclic alkyl substituent group having from 5 to 12 carbon atoms per group and the term “(meth)acrylamide” refers collectively to acrylamides and methacrylamides.

In some cases the rubbery phase of the emulsion polymer is derived from polymerization of a butadiene, C₄-C₁₂ acrylates or combination thereof with a rigid phase derived from polymerization of styrene, C₁-C₃ acrylates, methacrylates, acrylonitrile or combinations thereof where at least a portion of the rigid phase is grafted to the rubbery phase. In other instances more than half of the rigid vinyl phase will be grafted to the rubbery phase.

Suitable vinyl aromatic monomers include, e.g., styrene and substituted styrenes having one or more alkyl, alkoxyl, hydroxyl or halo substituent group attached to the aromatic ring, including, e.g., α-methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers. As used herein, the term “monoethylenically unsaturated nitrile monomer” means an acyclic compound that includes a single nitrile group and a single site of ethylenic unsaturation per molecule and includes, e.g., acrylonitrile, methacrylonitrile, α-chloro acrylonitrile.

In an alternative embodiment, the rubber is a copolymer, preferably a block copolymer, comprising structural units derived from one or more conjugated diene monomers and up to 90 percent by weight (“wt %”) structural units derived from one or more monomers selected from vinyl aromatic monomers and monoethylenically unsaturated nitrile monomers, such as, for example, a styrene-butadiene copolymer, an acrylonitrile-butadiene copolymer or a styrene-butadiene-acrylonitrile copolymer. In another embodiment, the rubber is a styrene-butadiene block copolymer that contains from 50 to 95 wt % structural units derived from butadiene and from 5 to 50 wt % structural units derived from styrene.

The emulsion derived polymers can be further blended with non-emulsion polymerized vinyl polymers, such as those made with bulk or mass polymerization techniques. A process to prepare mixtures containing polycarbonate, calcined hydrotalcite, an emulsion derived vinyl polymer, along with a bulk polymerized vinyl polymers, with improved hydrolytic resistance is also contemplated.

The elastomeric phase may be made by aqueous emulsion polymerization in the presence of a radical initiator, a surfactant and, optionally, a chain transfer agent and coagulated to form particles of elastomeric phase material. Suitable initiators include conventional free radical initiator such as, e.g., an organic peroxide compound, such as e.g., benzoyl peroxide, a persulfate compound, such as, e.g., potassium persulfate, an azonitrile compound such as, e.g., 2,2′-azobis-2,3,3-trimethylbutyronitrile, or a redox initiator system, such as, e.g., a combination of cumene hydroperoxide, ferrous sulfate, tetrasodium pyrophosphate and a reducing sugar or sodium formaldehyde sulfoxylate. Suitable chain transfer agents include, for example, a (C₉-C₁₃) alkyl mercaptan compound such as nonyl mercaptan, t-dodecyl mercaptan. Suitable emulsion aids include, linear or branched carboxylic acid salts, from with about 10 to 30 carbon atoms. Suitable salts include ammonium carboxylates and alkaline carboxylates; such as ammonium stearate, methyl ammonium behenate, triethyl ammonium stearate, sodium stearate, sodium iso-stearate, potassium stearate, sodium salts of tallow fatty acids, sodium oleate, sodium palmitate, potassium linoleate, sodium laurate, potassium abieate (rosin acid salt), sodium abietate and combinations thereof. Often mixtures of fatty acid salts derived from natural sources such as seed oils or animal fat (such as tallow fatty acids) are used as emulsifiers.

In one embodiment, the emulsion polymerized particles of elastomeric phase material have a weight average particle size of 50 to 800 nanometers (“nm”), more preferably, of from 100 to 500 nm, as measured by light transmission. The size of emulsion polymerized elastomeric particles may optionally be increased by mechanical, colloidal or chemical agglomeration of the emulsion polymerized particles, according to known techniques.

The rigid thermoplastic resin phase comprises one or more vinyl derived thermoplastic polymers and exhibits a T_{g} of greater than 25° C., preferably greater than or equal to 90° C. and even more preferably greater than or equal to 100° C.

In another instance, the rigid thermoplastic resin phase comprises a vinyl aromatic polymer having first structural units derived from one or more vinyl aromatic monomers, preferably styrene, and having second structural units derived from one or more monoethylenically unsaturated nitrile monomers, preferably acrylonitrile. In other cases, the rigid phase comprises from 55 to 99 wt %, still more preferably 60 to 90 wt %, structural units derived from styrene and from 1 to 45 wt %, still more preferably 10 to 40 wt %, structural units derived from acrylonitrile.

The amount of grafting that takes place between the rigid thermoplastic phase and the rubber phase may vary with the relative amount and composition of the rubber phase. In one embodiment, from 10 to 90 wt %, often from 25 to 60 wt %, of the rigid thermoplastic phase is chemically grafted to the rubber phase and from 10 to 90 wt %, preferably from 40 to 75 wt % of the rigid thermoplastic phase remains “free, i.e., non-grafted.

The rigid thermoplastic phase of the rubber modified thermoplastic resin may be formed: (i) solely by emulsion polymerization carried out in the presence of the rubber phase or (ii) by addition of one or more separately polymerized rigid thermoplastic polymers to a rigid thermoplastic polymer that has been polymerized in the presence of the rubber phase. In one embodiment, the weight average molecular weight of the one or more separately polymerized rigid thermoplastic polymers is from about 50,000 to about 100,000 g/mol.

In other cases, the rubber modified thermoplastic resin comprises a rubber phase having a polymer with structural units derived from one or more conjugated diene monomers, and, optionally, further comprising structural units derived from one or more monomers selected from vinyl aromatic monomers and monoethylenically unsaturated nitrile monomers, and the rigid thermoplastic phase comprises a polymer having structural units derived from one or more monomers selected from vinyl aromatic monomers and monoethylenically unsaturated nitrile monomers. In one embodiment, the rubber phase of the rubber modified graft copolymer comprises a polybutadiene or poly(styrene-butadiene) rubber and the rigid phase comprises a styrene-acrylonitrile copolymer. Vinyl polymers free of alkyl carbon-halogen linkages, specifically bromine and chlorine carbon bond linkages, are preferred for superior melt stability.

Another example of emulsion polymerized impact modifiers are polymers built up from a rubber-like core on which one or more shells have been grafted. Typical core material may consist substantially of an acrylate or butadiene rubber. The core may be an acrylate rubber of derived from, foe example, a C4 to C12 poly acrylate or methacrylate esters. It is convenient to use the term poly(meth)acrylates to encompass polymers comprising poly alkyl acrylates, poly alkyl methacrylates and copolymers thereof including, for example, random, block, branched, graft, core-shell and other molecular architectures. In some cases, one or more shells are grafted on the core. Often these shells are built up for the greater part from a vinyl aromatic compound and/or a vinyl cyanide and/or an alkyl(meth)acrylate and/or (meth)acrylic ester. The core and/or the shell(s) often further comprise multi-functional compounds that may act as a cross-linking agent and/or as a grafting agent. These polymers are usually prepared in several stages. The preparation of core-shell polymers and their use as impact modifiers in combination with polycarbonate are described in U.S. Pat. Nos. 3,864,428 and 4,264,487.

In some instances it is desirable to isolate the emulsion vinyl polymer or copolymer by coagulation in acid. In such instances the emulsion polymer may be contaminated by residual acid, or species derived from the action of such acid, for example carboxylic acids derived from fatty acid soaps used to form the emulsion. The acid used for coagulation may be a mineral acid; such as sulfuric acid, hydrochloric acid, nitric acid, phosphoric acid or mixtures thereof. In some cases the acid used for coagulation has a pH less than about 5.

Non limiting examples of emulsion polymerized vinyl polymers are; ABS acrylonitrile butadiene styrene polymer, ASA acrylonitrile alkyl acrylate styrene polymer, MBS methacrylate butadiene styrene, HIPS high impact polystyrene, SMA styrene maleic anhydride polymer, SAN styrene acrylonitrile polymer, alkyl (meth)acrylate rubbers and mixtures thereof.

The compositions of the invention can also be combined with various additives including, but not limited to, colorants such as titanium dioxide, zinc sulfide and carbon black; stabilizers such as hindered phenols, phosphites, phosphonites, thioesters and mixtures thereof, as well as mold release agents, lubricants, flame retardants, smoke suppressors and anti-drip agents, for example, those based on fluoro polymers. Use of phosphonate or phosphite compounds or mixtures thereof may be desired in some instances to improve color and oxidative stability. In another instance triaryl phosphonate, phosphite compounds or mixtures thereof may be employed. Effective amounts of the additives vary widely, but they are usually present in an amount up to about 0.01-20% or more by weight, based on the weight of the entire composition. Flame retardants based on sulfonate salts, such a perfluoro alky metal sulfonates, aryl sulfonate salts or mixtures thereof, aryl phosphates and halogenated aromatic compounds may be useful. Ultraviolet light stabilizers can also be added to the compositions in effective amounts. Preferred mold release agents are alkyl carboxylic acid esters, for example, pentaerythritol tetrastearate, glycerin tristearate and ethylene glycol distearate. Mold release agents are typically present in the composition at 0.01-0.5% by weight of the formulation. Other examples of mold release agents are may also be alpha-olefins or low molecular weight poly alpha olefins, or blends thereof.

The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

The thermoplastic resin blends of PC and emulsion polymerization derived vinyl polymers can be formed into useful shaped articles by a variety of means such as; injection molding, extrusion, rotational molding, compression molding, blow molding, sheet or film extrusion , profile extrusion, gas assist molding, structural foam molding and thermoforming. Formed articles include, for example, computer and business machine housings, home appliances, trays, plates, handles, helmets, automotive parts such as instrument panels, cup holders, glove boxes, interior coverings and the like. Other examples of formed articles include, but are not limited to, food service items, medical devices, animal cages, electrical connectors, enclosures for electrical equipment, electric motor parts, power distribution equipment, communication equipment, computers and the like, including devices that have molded in snap fit connectors. The polycarbonate based blends described herein resins can also be made into film and sheet as well as components of laminate systems.

The process for improving hydrolytic stability of blends of PC with emulsion polymerized vinyl polymers comprises preparing a desired blend of PC with the emulsion polymerized vinyl polymer and adding varying amounts if calcined hydrotalcite, melt mixing the ingredients and testing the resultant mixture, or parts molded from it, for improved retention of properties after exposure to moisture. In this manner the optimal amount of calcined hydrotalcite needed to improve property retention after exposure to moisture, compared to similar blends with no added hydrotalcite, is determined. In some instances the amount of calcined hydrotalcite may be from 0.005 to 5.0 wt % of the formulation. In other cases the PC content may vary from 45-90 wt % of the blend the vinyl emulsion polymer content may range from 10-55wt %. The exposure to moisture can take place in various manners, for various times and at various temperatures. For example; the parts may be autoclaved for several cycles, they may be exposed to steam in a pressure cooker, they may be immersed in water or exposed to constant humidity at various temperatures. A useful method is to expose molded parts to a constant relative humidity of 95% at 90° C. for 500 or 1000 hours. Some methods that may be used to determine retention of properties after exposure to moisture are; retention of melt viscosity, retention of impact strength, such as Izod impact and retention of flexural or tensile strength. These tests are well known to those skilled in the art and can be measured by various standardized procedures such as ASTM and ISO methods.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

All patents cited herein are incorporated by reference.

### EXAMPLES

All samples were prepared by melt extrusion on a Werner & Pfleiderer Twin screw extruder, using a nominal melt temperature of 275° C., 25 inches of vacuum, and 250-500 rpm. Tests were all conducted in accordance with ISO standards, referenced in each test as follows: Tensile testing, 4 mm thick molded tensile bar ISO 527. Izod Impact, 4 mm thick bar, cut from molded tensile bar ISO 180/1A. Izod impact was done at 23 and −30° C. Tensile strength is measured at yield. HDT (Heat Distortion Temperature) was measured as per ISO 75 Af, at 1.8 MPa on a 4 mm thick bar injection molded sample, cut from molded tensile bar. Samples were subjected to 95% relative humidity (RH) at 90° C. for 500 or 1000 hrs. and tested for retention of properties vs. as molded samples of the same composition.

Materials: HF PC is a BPA polycarbonate with Mw 21,900, 105 PC is a BPA PC with Mw about 29,900. SAN is a styrene (ST) acrylonitrile (AN) copolymer, melt flow rate about 6.0 g/10 min. at 190° C./2.16 kg, AN content 25%, ST content 75% made by bulk polymerization. Calcined hydrotalcite was supplied by Kisuma Co. grade DHT-4C, with an average particle size of about 0.4 microns and a MgO/Al₂O₃ mole ratio of about 4.5. ABS-1 70% pBD is an emulsion polymerized acrylonitrile butadiene styrene polymer, BLENDEX 338, from GE Plastics, with about 70% polybutadiene (pBD), 7.5% AN and 22.5%ST. ABS-2 50% pBD is an emulsion polymerized acrylonitrile butadiene styrene polymer with about 50% polybutadiene, 12.5 % AN and 37.5% AN. ABS-3 62% pBD is an emulsion polymerized acrylonitrile butadiene styrene polymer with 62% polybutadiene. In addition each blend had 0.3 wt % hindered phenol stabilizer, 0.1 wt % triaryl phosphite stabilizer, 0.2 wt % thioester stabilizer and 0.15% pentaerythritol tetrastearate mold release agent.

Tables 1, 2 and 3 show that the calcined hydrotalcite gives improved retention of N. Izod and tensile strength vs. control experiments with no additive. It is necessary to determine the level of calcined hydrotalcite need to achieve retention of properties. Note that the different types of emulsion polymers; ABS-1 70% pBD, ABS-2 50% pBD and ABS-3 62% pBD require slightly differing levels of hydrotalcite to achieve improved hydrolytic stability. This is consistent with the differing levels of residues left from the emulsion polymerization processes use in each type of ABS resin. In all cases HDT at 1.8 MPa is over 100° C. Control experiments are designated by letter; examples of the invention are designated by number. The indication 90° C./95% RH refers to samples aged at 90° C. at 95% relative humidity for either 500 or 1000 hours.

TABLE 1
Examples

| | A | 1 | 2 | 3 |
|---|---|---|---|---|
| HF PC | 20.5 | 20.5 | 20.5 | 20.5 |
| 105 PC | 47.95 | 47.95 | 47.95 | 47.95 |
| ABS-1 70% pBD | 12.1 | 12.1 | 12.1 | 12.1 |
| SAN | 18.7 | 18.7 | 18.7 | 18.7 |
| Calcined-Hydrotalcite | 0 | 0.05 | 0.06 | 0.1 |
| N. Izod 23 C., kJ/m2 as | 90.3 | 85.7 | 80.0 | 77.1 |
| molded | | | | |
| N. Izod 23 C., 90 C./95% RH, | 5.1 | 4.7 | 5.4 | 10.9 |
| 500 hr | | | | |
| N. Izod 23 C., 90 C./95% RH, | 0.9 | 0.7 | 0.6 | 1.0 |
| 1000 hr | | | | |
| N. Izod −30 C., kJ/m2 as | 53.0 | 55.8 | 60.0 | 52.5 |
| molded | | | | |
| N. Izod −30 C., 90 C./95% | 2.5 | 6.3 | 3.8 | 17.5 |
| RH, 500 hr | | | | |
| N. Izod −30 C., 90 C./95% | 0.8 | 0.6 | 0.7 | 0.9 |
| RH, 1000 hr | | | | |
| Ten. Mod. 23 C. MPa as | 2364 | 2328 | 2366 | 2354 |
| molded | | | | |
| Ten Mod. 90 C./95% RH, | 2651 | | 2534 | 2558 |
| 1000 hr | | | | |
| Ten. Y. Str. 23 C. MPa as | 54 | 54 | 54 | 53 |
| molded | | | | |
| Ten. Y. Str. 90 C./95% RH, | 39 | 32 | 33 | 60 |
| 500 hr | | | | |
| Ten. Y. Str. 90 C./95% RH, | 8 | 8 | 9 | 34 |
| 1000 hr | | | | |
| HDT ° C. 1.8 MPa | 105 | 106 | 108 | 107 |

TABLE 2
Examples

| | B | 4 | 5 | 6 | 7 |
|---|---|---|---|---|---|
| HF PC | 20.5 | 20.5 | 20.5 | 20.5 | 20.5 |
| 105 PC | 47.95 | 47.95 | 47.95 | 47.95 | 47.95 |
| ABS-2 50% pBD | 18.1 | 18.1 | 18.1 | 18.1 | 18.1 |
| SAN | 12.7 | 12.7 | 12.7 | 12.7 | 12.7 |
| Calcined-Hydrotalcite | 0 | 0.025 | 0.05 | 0.1 | 0.2 |
| N. Izod 23 C., kJ/m2 | 65.3 | 56.0 | 65.5 | 59.0 | 59.5 |
| as molded | | | | | |
| N. Izod 23 C., 90 C./ | 22.2 | 36.3 | 35.8 | 35.8 | 41.4 |
| 95% RH, 500 hr | | | | | |
| N. Izod 23 C., 90 C./ | 0.8 | 4.5 | 5.3 | 5.2 | 33.3 |
| 95% RH, 1000 hr | | | | | |
| N. Izod −30 C., kJ/m2 | 59.9 | 63.4 | 53.2 | 50.0 | 46.4 |
| as molded | | | | | |
| N. Izod −30 C., 90 C./ | 20.2 | 27.6 | 26.1 | 29.1 | 42.6 |
| 95% RH, 500 hr | | | | | |
| N. Izod −30 C., 90 C./ | 0.8 | 5.5 | 6.2 | 3.0 | 16.0 |
| 95% RH, 1000 hr | | | | | |
| Ten. Mod. 23 C. | 2269 | 2287 | 2287 | 2232 | 2259 |
| MPa as molded | | | | | |
| Ten. Mod. 90 C./ | 2593 | 2498 | 2476 | 2483 | 2447 |
| 95% RH, 1000 hr | | | | | |
| Ten. Y. Str. 23 C. | 52 | 52 | 52 | 51 | 51 |
| MPa as molded | | | | | |
| Ten. Y. Str. 90 C./ | 60 | 58 | 59 | 43 | 56 |
| 95% RH, 500 hr | | | | | |
| Ten. Y. Str. 90 C./ | 13 | 40 | 35 | 14 | 58 |
| 95% RH, 1000 hr | | | | | |
| HDT ° C. 1.8 MPa | 105 | 106 | 108 | 107 | 105 |

TABLE 3
Examples

| | C | 8 | 9 | 10 |
|---|---|---|---|---|
| HF PC | 20.5 | 20.5 | 20.5 | 20.5 |
| 105 PC | 47.95 | 47.95 | 47.95 | 47.95 |
| ABS-3 62% pBD | 14.6 | 14.6 | 14.6 | 14.6 |
| SAN | 16.2 | 16.2 | 16.2 | 16.2 |
| Calcined-Hydrotalcite | 0 | 0.05 | 0.075 | 0.1 |
| N. Izod 23 C., kJ/m2 as | 53.6 | 75.0 | 51.5 | 67.2 |
| molded | | | | |
| N. Izod 23 C., 90 C./95% RH, | 10.6 | 12.5 | 14.0 | 11.5 |
| 500 hr | | | | |
| N. Izod 23 C., 90 C./95% RH, | 0.6 | 1.2 | 0.5 | 0.7 |
| 1000 hr | | | | |
| N. Izod −30 C., kJ/m2 as | 50.1 | 60.0 | 53.4 | 57.0 |
| molded | | | | |
| N. Izod −30 C., 90 C./95% | 17.9 | 17.3 | 22.1 | 18.1 |
| RH, 500 hr | | | | |
| N. Izod −30 C., 90 C./95% | 0.6 | 1.2 | 0.5 | 0.9 |
| RH, 1000 hr | | | | |
| Ten. Mod. 23 C. MPa as | 2296 | 2311 | 2307 | 2259 |
| molded | | | | |
| Ten. Mod. 90 C./95% RH, | 2577 | 2530 | 2541 | 2553 |
| 1000 hr | | | | |
| Ten. Y. Str. 23 C. MPa as | 54 | 54 | 53 | 54 |
| molded | | | | |
| Ten. Y. Str. 90 C./95% RH, | 63 | 63 | 52 | 38 |
| 500 hr | | | | |
| Ten. Y. Str. 90 C./95% RH, | 11 | 24 | 12 | 13 |
| 1000 hr | | | | |
| HDT ° C. 1.8 MPa | 108 | 106 | 107 | 109 |

We claim the following:

1) A composition with improved hydrolytic stability comprising a mixture of polycarbonate, an emulsion based polymer, and calcined alumino magnesium carbonate in an amount effective to provide improved hydrolytic stability to the composition.

2) The composition of claim I wherein the calcined alumino magnesium carbonate is a calcined hydrotalcite.

3) The composition of claim 1 wherein the amount of calcined alumino magnesium carbonate is from 0.005 to 5.0 wt % of the polycarbonate and emulsion based polymer composition.

4) The composition of claim 1 wherein the calcined alumino magnesium carbonate has a magnesium oxide to aluminum oxide mole ratio of about 1.0 to 5.0.

5) The composition of claim 1 wherein the alumino magnesium carbonate has an average particle size of less than or equal to about 10 microns.

6) The composition of claim 1 wherein the calcined alumino magnesium carbonate has less than about 30 ppm of elements selected from the group consisting of:
mercury, lead, cadmium, arsenic, bismuth and mixtures thereof.

7) The composition of claim 1 wherein the emulsion based polymer is at least a member selected from the group consisting of poly acrylonitrile butadiene styrene, poly acrylonitrile styrene (meth)acrylate, poly alkyl(meth)acrylate butadiene styrene, poly alky(meth)acrylates, poly styrene acrylonitrile, poly styrene maleic anhydride, poly acrylonitrile butadiene acrylate, and combinations thereof.

8) The composition of claim 1 wherein the emulsion based polymer is coagulated with acid.

9) The composition of claim 8 wherein the acid has pH of less than about 5.0.

10) The composition of claim 1 wherein the ratio of polycarbonate to emulsion based polymer is about 20:80 to 95:5.

11) The composition of claim 10 wherein the ratio of polycarbonate to emulsion based polymer is a mixture of from 45-90 wt % polycarbonate, 0-30 wt % polystyrene acrylonitrile, 5-35% poly acrylonitrile butadiene styrene and 0.05 to 0.5 wt % calcined hydrotalcite.

12) The composition of claim 11 wherein the polystyrene acrylonitrile has 20-40 wt % units derived by polymerization of acrylonitrile.

13) The composition of claim 1 wherein the polycarbonate has a weight average molecular weight of 15,000-80,000.

14) The composition of claim 1 further comprising the addition of a phosphite stabilizer.

15) The composition of claim 1 wherein the blends of polycarbonate with emulsion derived vinyl polymers and calcined alumino magnesium carbonate retain at least about 50% of the initial tensile strength of the composition, as measured by IS0527, after exposure to about 95% relative humidity for about 500 hours at about 90° C.

16) The composition of claim 15 wherein the initial tensile strength is from about 30 to 70 Mpa.

17) The composition of claim 1 wherein the stabilized polycarbonate, emulsion polymer and calcined alumino magnesium carbonate blends have a HDT, as measured at 1.8 Mpa, by ISO method 75 Af, from 100 to 150° C.

18) A composition with improved hydrolytic stability comprising blends of polycarbonate with emulsion derived vinyl polymers and calcined alumino magnesium carbonate which retain at least about 50% of the initial Izod impact strength of the composition, as measured by IS0180, after exposure to about 95% relative humidity for about 500 hours at about 90° C.

19) The composition of claim 18 wherein the initial Izod impact strength of the stabilized polycarbonate, emulsion polymer and calcined alumino magnesium carbonate blends is greater than about 40 kJ/m2.

20) A composition with improved hydrolytic stability comprising blends of 45-90 wt % polycarbonate with 10-45 wt % emulsion derived acrylonitrile butadiene styrene polymers and 0.001-1.0 wt % calcined alumino magnesium carbonate which retain at least about 50% of the initial tensile strength of the composition, as measured by IS0527, after exposure to about 95% relative humidity for about 500 hours at about 90° C.

21) A process to improve the stability of blends of polycarbonate with emulsion derived vinyl polymers comprising the addition of sufficient calcined alumino magnesium carbonate to retain at least about 50% of the initial tensile strength of the composition, as measured by IS0527, after exposure to about 95% relative humidity for about 500 hours at about 90° C.

22) The process of claim 21 wherein the sufficient amount of calcined alumino magnesium carbonate is from 0.005 to 5.0 wt % of the polycarbonate and emulsion based polymer composition.

23) The process of claim 21 wherein the initial tensile strength is from about 30 to 70 Mpa.

24) The process of claim 21 wherein the calcined alumino magnesium carbonate has a magnesium oxide to aluminum oxide mole ratio of about 1.0 to 5.0.

25) The process of claim 21 wherein the calcined alumino magnesium carbonate has an average particle size of less than or equal to about 10 microns.

26) The process of claim 21 wherein the calcined alumino magnesium carbonate has less than about 30 ppm of elements selected from the group consisting of:
mercury, lead, cadmium, arsenic, bismuth, and mixtures thereof.

27) The process of claim 21 wherein the emulsion based polymer is at least a member selected from the group consisting of the group consisting of poly acrylonitrile butadiene styrene, poly acrylonitrile styrene (meth)acrylate, poly alkyl(meth)acrylate butadiene styrene, poly alky(meth)acrylates, poly styrene acrylonitrile, poly styrene maleic anhydride, poly acrylonitrile butadiene acrylate and combinations thereof.

28) The process of claim 21 wherein the emulsion based polymer is coagulated with acid.

29) The process of claim 28 wherein the acid has pH of less than about 5.0.

30) The process of claim 21 wherein the ratio of polycarbonate to emulsion based polymer is about 20:80 to 95:5.

31) The process of claim 30 wherein the ratio of polycarbonate to emulsion based polymer is a mixture of from 45-90 wt % polycarbonate, 0-30 wt % polystyrene acrylonitrile, 5-35% poly acrylonitrile butadiene styrene and 0.05 to 0.5 wt % calcined hydrotalcite.

32) The process of claim 31 wherein the polystyrene acrylonitrile has 20-40 wt % units derived by polymerization of acrylonitrile.

33) The process of claim 21 wherein the stabilized polycarbonate, emulsion polymer, calcined alumino magnesium carbonate blends have a HDT, as measured at 1.8 Mpa, by ISO method 75 Af, from 100 to 150° C.

34) The process of claim 21 wherein the polycarbonate has a weight average molecular weight of 15,000-80,000.

35) The process of claim 21 further comprising the addition of a phosphite stabilizer.

36) The process of claim 21 where the calcined alumino magnesium carbonate is a calcined hydrotalcite.

37) A composition made by the process of claim 21.

38) A molded article made by the composition of claim 37.

39) A process to improve the stability of blends of polycarbonate with emulsion derived vinyl polymers comprising the addition of sufficient calcined alumino magnesium carbonate to retain at least about 50% of the initial Izod impact strength of the composition, as measured by IS0180, after exposure to about 95% relative humidity for about 500 hours at about 90° C.

40) The process of claim 39 wherein the initial Izod impact strength of the stabilized polycarbonate, emulsion polymer, calcined alumino magnesium carbonate blends is greater than about 40 kJ/m2.

41) A process to improve the stability of blends of 45-90 wt % polycarbonate with 10-45 wt % emulsion derived acrylonitrile butadiene styrene polymers comprising the addition of 0.001-1.0 wt % calcined alumino magnesium carbonate to retain at least about 50% of the initial tensile strength of the composition, as measured by IS0527, after exposure to about 95% relative humidity for about 500 hours at about 90° C.

42) A molded article made by the composition of claim 1.
